(19) United States
(12) Patent Application Publication
(10) Pub. No.: US 2019/0059029 A1
(43) Pub. Date: Feb. 21, 2019

(54) Hybrid Solution for Network Controlled Handover and UE Autonomous Handover

(71) Applicant: Nokia Solutions and Networks Oy, Espoo (FI)

(72) Inventors: Jari Petteri LUNDEN, Espoo (FI); Elena VIRTEJ, Espoo (FI); Lars DALSGAARD, Oulu (FI)

(21) Appl. No.: 16/070,547

(22) PCT Filed: Jan. 20, 2017
(86) PCT No.: PCT/EP2017/051253

§ 371 Date: Jul. 17, 2018

(30) Foreign Application Priority Data
Jan. 21, 2016 (EP) PCT/EP2016/051264

(51) Int. Cl. H04W 36/00

(52) U.S. Cl. CPC H04W 36/00837; H04W 72/0446; H04W 36/0058

(57) ABSTRACT

There is provided a method comprising including determining, at a user device, the occurrence of a first event, the first event being an indication to, after a first time period, provide a measurement report to a serving access point of a network, determining, at the user device, whether a second event has occurred, the second event being an indication to, after a second time period, initiate user device controlled handover from the serving access point of the network, determining whether a handover command has been received from the network in response to the measurement report and prior to expiry of the second time period and, if not, determining to initiate user device controlled handover.

### FIELD

The present application relates to a method, apparatus, system and computer program and in particular but not exclusively to standalone operation in unlicensed spectrum.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimising the 3GPP LTE radio access technologies.

### SUMMARY

In a first aspect there is provided a method comprising determining, at a user device, the occurrence of a first event, the first event being an indication to, after a first time period, provide a measurement report to a serving access point of a network, determining, at the user device, whether a second event has occurred, the second event being an indication to, after a second time period, initiate user device controlled handover from the serving access point of the network, determining whether a handover command has been received from the network in response to the measurement report and prior to expiry of the second time period and, if not, determining to initiate user device controlled handover.

The first time period may be a time to trigger providing the measurement report from the first event. The second time period may be a second time to trigger initiating user device controlled handover from the second event.

The second time period may be greater than the first time period.

The method may comprise providing the measurement report to the network and determining whether the measurement report was successfully provided to the network

The user device may be configured with two second time periods, the two second time periods having different lengths. The method may comprise determining to use the shorter of the two second time periods if the measurement report has been successfully provided to the network and the longer of the two second time periods if the measurement report has not been successfully provided to the network.

The method may comprise providing the measurement report to the network prior to determining whether the second event has occurred.

The second time period may be configured to begin on expiry of the first time period and the second time period is less than or equal to the first time period.

The first event may comprise a neighbour access point having a first offset with respect to the serving access point.

The second event may comprise a neighbour access point having a second offset with respect to the serving access point.

The first offset may be less than or equal to the second offset.

The method may comprise performing a listen-before-talk procedure and determining to initiate user device controlled handover in dependence on whether the serving access point is available.

In a second aspect there is provided an apparatus, said apparatus comprising means for determining, at a user device, the occurrence of a first event, the first event being an indication to, after a first time period, provide a measurement report to a serving access point of a network, means for determining, at the user device, whether a second event has occurred, the second event being an indication to, after a second time period, initiate user device controlled handover from the serving access point of the network, means for determining whether a handover command has been received from the network in response to the measurement report and prior to expiry of the second time period and means for, if not, determining to initiate user device controlled handover.

The first time period may be a time to trigger providing the measurement report from the first event. The second time period may be a second time to trigger initiating user device controlled handover from the second event.

The second time period may be greater than the first time period.

The apparatus may comprise means for providing the measurement report to the network and means for determining whether the measurement report was successfully provided to the network

The user device may be configured with two second time periods, the two second time periods having different lengths. The apparatus may comprise means for determining to use the shorter of the two second time periods if the measurement report has been successfully provided to the network and the longer of the two second time periods if the measurement report has not been successfully provided to the network.

The apparatus may comprise means for providing the measurement report to the network prior to determining whether the second event has occurred.

The second time period may be configured to begin on expiry of the first time period and the second time period is less than or equal to the first time period.

The first event may comprise a neighbour access point having a first offset with respect to the serving access point.

The second event may comprise a neighbour access point having a second offset with respect to the serving access point.

The first offset may be less than or equal to the second offset.

The apparatus may comprise means for performing a listen-before-talk procedure and means for determining to initiate user device controlled handover in dependence on whether the serving access point is available.

In a third aspect there is provided an apparatus comprising at least one processor and at least one memory including a computer program code, the at least one memory and the computer program code configured to, with the at least one processor, cause the apparatus at least to determine, at a user device, the occurrence of a first event, the first event being an indication to, after a first time period, provide a measurement report to a serving access point of a network, determine, at the user device, whether a second event has occurred, the second event being an indication to, after a second time period, initiate user device controlled handover from the serving access point of the network, determine whether a handover command has been received from the network in response to the measurement report and prior to expiry of the second time period and, if not, determine to initiate user device controlled handover.

The first time period may be a time to trigger providing the measurement report from the first event. The second time period may be a second time to trigger initiating user device controlled handover from the second event.

The second time period may be greater than the first time period.

The apparatus may be configured to provide the measurement report to the network and determine whether the measurement report was successfully provided to the network

The user device may be configured with two second time periods, the two second time periods having different lengths. The apparatus may be configured to determine to use the shorter of the two second time periods if the measurement report has been successfully provided to the network and the longer of the two second time periods if the measurement report has not been successfully provided to the network.

The apparatus may be configured to provide the measurement report to the network prior to determining whether the second event has occurred.

The second time period may be configured to begin on expiry of the first time period and the second time period is less than or equal to the first time period.

The first event may comprise a neighbour access point having a first offset with respect to the serving access point.

The second event may comprise a neighbour access point having a second offset with respect to the serving access point.

The first offset may be less than or equal to the second offset.

The apparatus may be configured to perform a listen-before-talk procedure and determine to initiate user device controlled handover in dependence on whether the serving access point is available.

In a fourth aspect there is provided a computer program embodied on a non-transitory computer-readable storage medium, the computer program comprising program code for controlling a process to execute a process, the process comprising determining, at a user device, the occurrence of a first event, the first event being an indication to, after a first time period, provide a measurement report to a serving access point of a network, determining, at the user device, whether a second event has occurred, the second event being an indication to, after a second time period, initiate user device controlled handover from the serving access point of the network, determining whether a handover command has been received from the network in response to the measurement report and prior to expiry of the second time period and, if not, determining to initiate user device controlled handover.

The first time period may be a time to trigger providing the measurement report from the first event. The second time period may be a second time to trigger initiating user device controlled handover from the second event.

The second time period may be greater than the first time period.

The process may comprise providing the measurement report to the network and determining whether the measurement report was successfully provided to the network

The user device may be configured with two second time periods, the two second time periods having different lengths. The process may comprise determining to use the shorter of the two second time periods if the measurement report has been successfully provided to the network and the longer of the two second time periods if the measurement report has not been successfully provided to the network.

The process may comprise providing the measurement report to the network prior to determining whether the second event has occurred.

The second time period may be configured to begin on expiry of the first time period and the second time period is less than or equal to the first time period.

The first event may comprise a neighbour access point having a first offset with respect to the serving access point.

The second event may comprise a neighbour access point having a second offset with respect to the serving access point.

The first offset may be less than or equal to the second offset.

The process may comprise performing a listen-before-talk procedure and determining to initiate user device controlled handover in dependence on whether the serving access point is available.

In a fifth aspect there is provided a computer program product for a computer, comprising software code portions for performing the steps the method of the first and second aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 illustrates UE outage time at 3 km/h and 60 km/h using network controlled (NW) handover (HO);

FIG. 4 illustrates UE outage time at 3 km/h and 60 km/h using UE autonomous HO;

FIG. 5 shows a flowchart of an example method according to an embodiment;

FIG. 6 shows a flowchart of an example method according to an embodiment;

FIG. 7 shows a schematic diagram of an example control apparatus; FIG. 7 shows a schematic diagram of an example control apparatus;

### DETAILED DESCRIPTION

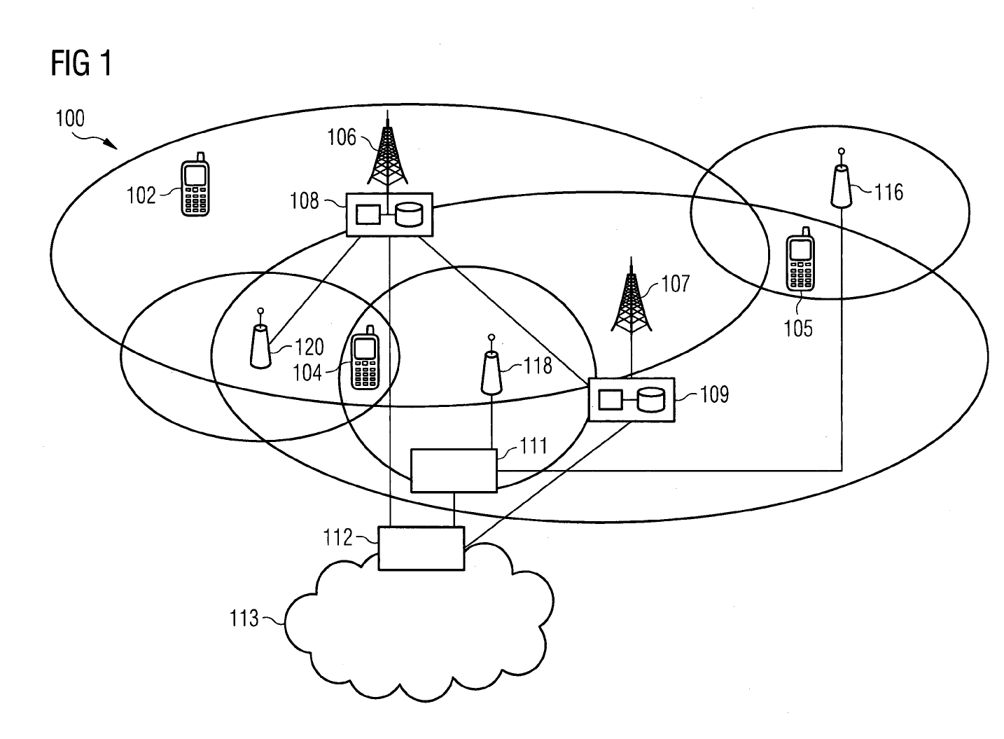

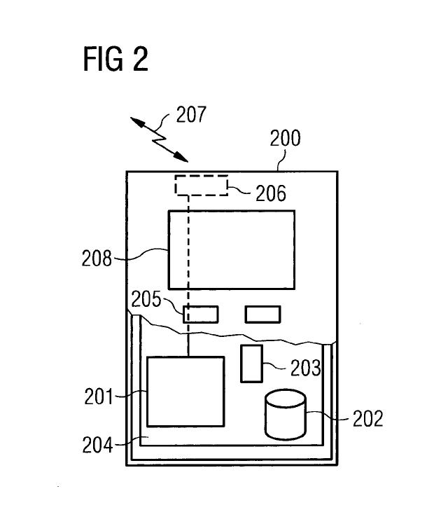

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signalling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Wireless communication systems may be licensed to operate in particular spectrum bands. A technology, for example LTE, may operate, in addition to a licensed band, in an unlicensed band. One proposal for operating in unlicensed spectrum is Licensed-Assisted Access (LAA). LAA may imply that a connection via a licensed band is maintained while using the unlicensed band. Moreover, in LAA, the licensed and unlicensed bands may be operated together using, e.g., carrier aggregation or dual connectivity. For example, carrier aggregation (CA) between primary cell (PCell) on a licensed band and one or more secondary cells (Scells) on unlicensed band may be applied.

LTE-LAA may provide licensed-assisted access to unlicensed spectrum while coexisting with other technologies and fulfilling regulatory requirements. In Rel-13 LAA, unlicensed spectrum is accessed to improve LTE DL throughput. In LTE LAA, the LAA downlink (DL) Scell may be configured for an UE as part of DL CA configuration, while the Pcell uses licensed spectrum. Rel-13 LTE LAA may evolve to support LAA uplink (UL) transmissions on unlicensed spectrum in LTE Rel-14. Unlicensed band operation may involve e.g. up to 5 GHz frequency spectrum. Other frequencies may be considered as well.

LAA with dual connectivity operation (i.e. assuming non-ideal backhaul between Pcell in licensed spectrum and Scell(s) in unlicensed spectrum) and standalone LTE operation on unlicensed spectrum has been considered. LTE standalone operation on unlicensed spectrum means that eNB/UE air interface relies solely on unlicensed spectrum without any carrier on licensed spectrum. An example of LTE standalone operation in unlicensed bands is Qualcomm's recent announcement of MuLTEfire technology.

By bringing the benefits of LTE technologies to unlicensed spectrum, LTE standalone operation in unlicensed spectrum, such as MuLTEFire, may provide enhanced coverage, capacity and mobility. That is, mobility within the unlicensed spectrum independently from, e.g., LTE in licensed band may be supported. Technology such as MulteFire may act as a ‘neutral host’ with the ability to serve users from multiple operators, especially in hard to reach places such as indoor locations, venues and enterprises. That is, standalone operation may be seen as a second system or connection e.g. while also being connected to LTE in licensed band.

In some jurisdictions, unlicensed technologies may need to abide by certain regulations, e.g. requiring use of Listen-Before-Talk (LBT) procedure, in order to provide fair coexistence between LTE and other technologies such as Wi-Fi, as well as between LTE operators.

In a standalone system on unlicensed band/carrier the mobility becomes more challenging compared to the LTE system on licensed carrier. This may be due to regulations requiring a successful LBT/CCA procedure before transmitting. Since the LBT/CCA is applied on both eNB and UE side, and may include transmission of reference signals used for measurements, overall delays related to measurements, reporting and handover related signalling may be increased.

Network controlled HO procedure is known from LTE specs TS36.331 and TS36.300. UE autonomous HO or forward HO has been also proposed for LTE.

Network controlled HO is the legacy LTE HO, where a UE is configured to perform neighbour cell measurements and report those measurements based on configured events (e.g. neighbour cell more than offset stronger than serving cell). Depending on the signal quality of different cells, load situation, UE mobility state etc., the network/eNB decides when and where UE performs a handover. The network then prepares the HO with the target cell (e.g. by signalling over X2) and sends UE a HO command (e.g. RRC reconfiguration including mobility control IE), which instructs UE to make a HO to the target cell.

In autonomous HO, UE determines to perform HO and itself initiates the procedure without explicit decision or signalling from the network. Although the HO is said to be autonomous, the network may (depending on how autonomous HO is implemented) configure UE with some restrictions such as carrier or list of accepted target cells, so the HO may not be fully autonomous. In the case of autonomous HO, UE context is provided to a target cell from the source cell using context fetch procedure (signalling over X2, similar to HO preparation but originated by the target cell). To support this the UE, when autonomously establishing the connection to the target cell, indicates the source cell so that the UE context can be fetched from the correct place.

Network (NW) controlled handover (HO) (legacy LTE HO procedure) may work well under certain conditions e.g. in situations with low load and/or low UE speed. Under more challenging conditions, such as high network load and/or high UE speed, robust network controlled handover cannot be ensured; UE autonomous HO/mobility on the other hand may perform better.

Non-network controlled handover such as UE autonomous cell change may be slower when the target cell is an unprepared cell. Non-network controlled mobility may reduce the NW control of which cells are chosen by UE as target cell and is, as such, not baseline in LTE.

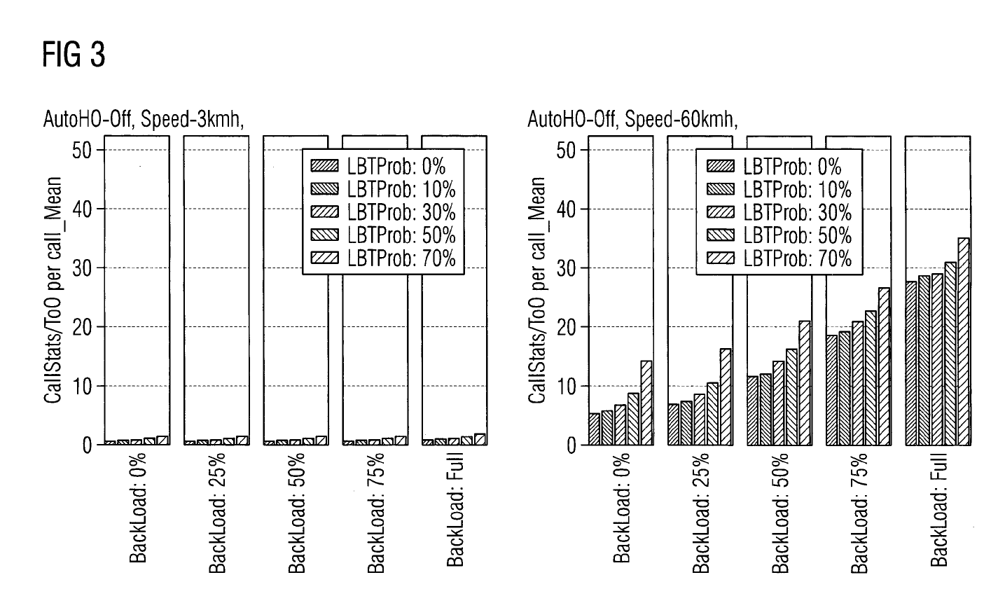

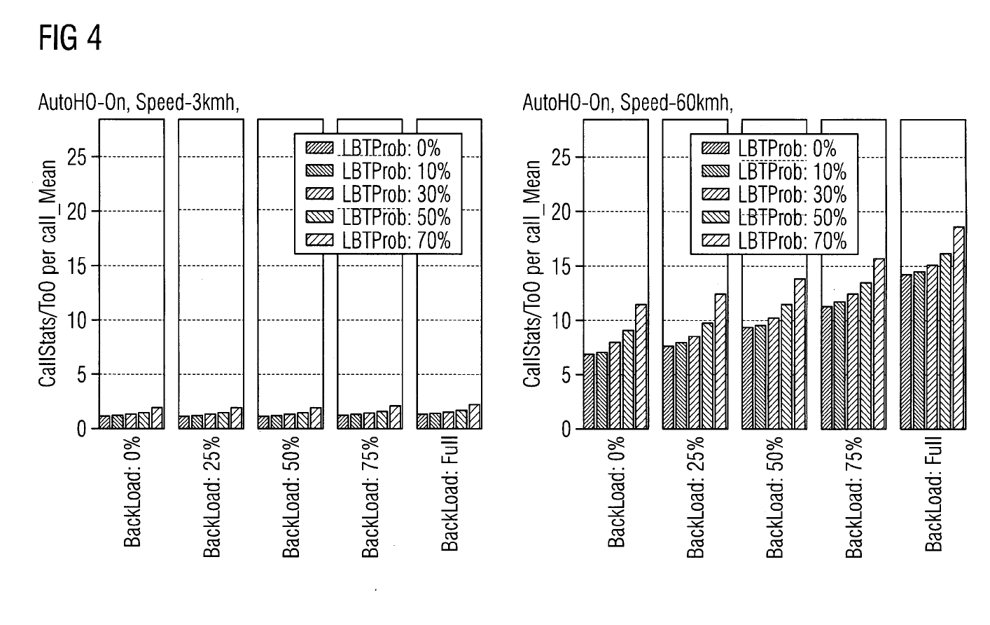

FIG. 3 shows system simulation results, for UE outage time (% of call) with network controlled HO. The outage is due to radio link failure (RLF), handover failure (HOF) and interruption inherent to HO. FIG. 4 shows system simulation result when autonomous handover is used. The outage is due to RLF, HOF and interruption due to autonomous HO (including delay for context fetch). It can be seen from FIGS. 3 and 4 that network controlled HO works well for low load or low UE speed (3 km/h), whereas autonomous HO improves the performance in terms of outage time for higher UE speed (e.g. 60 km/h) and higher network load. In FIG. 3 and FIG. 4, the LBTProb refers to the probability of LBT blocking a transmission (e.g. HO signalling, measurement report etc.) which includes blocking due to other network or WiFi interference. The term backload used in FIGS. 3 and 4 refers to the MuLTEFire network load in terms of percentage of resource blocks used.

When looking at the outage time, under the given conditions it is a challenge to ensure robust mobility using the baseline LTE HO mobility. Reducing the outage time in connection with HOs in unlicensed band (e.g. MulteFire) is desirable.

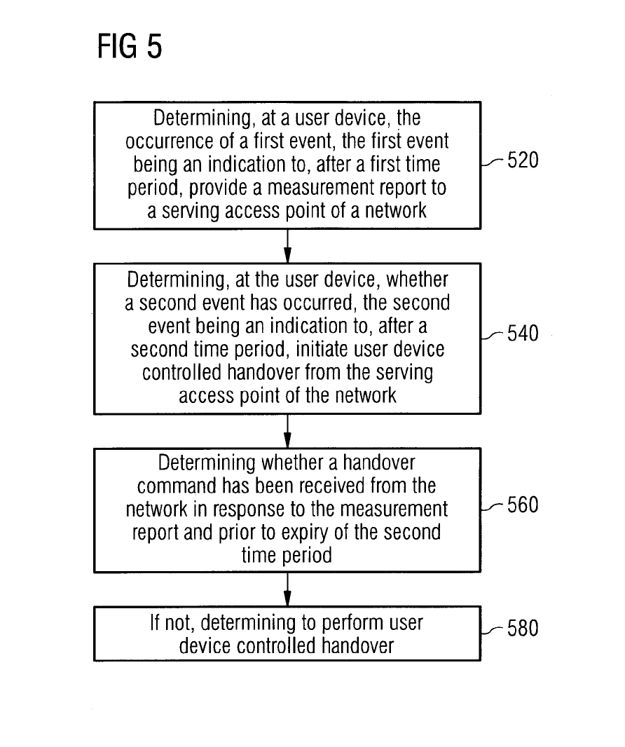

FIG. 5 shows a flowchart of an example method for enhancing mobility for LTE on unlicensed spectrum.

In a first step 520, the method comprises determining, at a user device, the occurrence of a first event, the first event being an indication to, after a first time period, provide a measurement report to a serving access point of a network.

In a second step 540, the method comprises determining, at the user device, whether a second event has occurred, the second event being an indication to, after a second time period, initiate user device controlled handover from the serving access point of the network.

In a third step 560, the method comprises determining whether a handover command has been received from the network in response to the measurement report and prior to expiry of the second time period; and, if not, in a fourth step, 580 determining to initiate user device controlled handover.

If the user device determines that the handover command has been received from the network in response to the measurement report and prior to expiry of the second time period, the user device initiates network controlled handover according to the contents of the handover command signalling.

A method such as that of FIG. 5 provides a hybrid solution combining NW controlled HO and UE autonomous HO. The intention is that UE, as a default, uses NW controlled (legacy) HO, but in those cases where NW controlled HO fails (or it is evident that it will fail, e.g., due to LBT/CCA blocking the transmission of HO signaling between UE and eNB), there is an UE autonomous HO action (instead of waiting for RLF and re-establishment).

The second event may be referred to as a second-level measurement or UE autonomous event, while the first event is a first level measurement or network controlled event.

An event may comprise, e.g., a neighbour access point having at least an offset (e.g. 2 dB) better quality (e.g. reference signal received power (RSRP) or reference signal received quality (RSRQ)) than the serving access point. The first event may comprise a neighbour access point having a first offset with respect to the serving access point. The second event may comprise a neighbour access point having a second offset with respect to the serving access point. The first offset may be less than or equal to the second offset. The event may be such that e.g. serving access point received signal power (or quality) becomes stronger/better than an absolute threshold, or e.g. neighbour access point becomes better than threshold, or e.g. neighbour access point becomes an offset better than serving access point (e.g. PCell/PSCell) etc.

The first time period is configured by network controlled event parameters, e.g. at least one of the offset, hysteresis, time to trigger (TTT). The first time period may comprise a first time to trigger (TTT) from the first event to providing a measurement report to the serving access point. A measurement report may indicate, e.g., that a neighbor cell has been measured to be stronger than the serving cell. Once the network receives the measurement report, it may initiate network controlled HO. Network controlled HO may comprise HO preparation of the source and target access points, and subsequently attempting to provide the user device with a HO command. That is, the first level event may be used for triggering the NW controlled handover, by triggering (triggering based on at least one of the configured for example, time to trigger (TTT) offset, hysteresis) UE to send a measurement report to the network/serving cell.

The first event may start the monitoring of second level event i.e. UE autonomous handover event. The user device may start monitoring for the second event before the measurement report is provided to the network, after the measurement report has been provided to the network and/or after determining that the measurement report has been provided to the network successfully.

The second time period is configured by NW for the UE to use for UE autonomous event parameters, e.g. at least one of the offset, hysteresis, time to trigger (TTT). The second time period may comprises a second time to trigger (ITT) from the second event to initiating UE autonomous HO.

The second level event has the triggering conditions (potentially including at least one of the e.g. TTT, offset, hysteresis etc.) for the UE autonomous mobility. If initiation of user device controlled HO is triggered (e.g., the second time period expires) before UE receives the network controlled HO command from the network (due to the first level event measurement report), the UE may initiate autonomous HO procedure.

The method may comprise performing a listen-before-talk procedure and determining to initiate user device controlled handover in dependence on whether the serving access point is available. In an exemplary additional embodiment, the second level event may have an additional condition related to LBT blocking. That is, the second level event may trigger initiation of the UE autonomous HO only if the source eNB is blocked by LBT (UE not receiving transmission from the source eNB because of this).

The triggering condition may include a certain blocking probability over a configured window (e.g. 200 ms), or a certain time of consecutive blocking (e.g. 50 ms, or some multiple of transmission opportunity (TxOp)/channel occupancy time (COT) lengths).

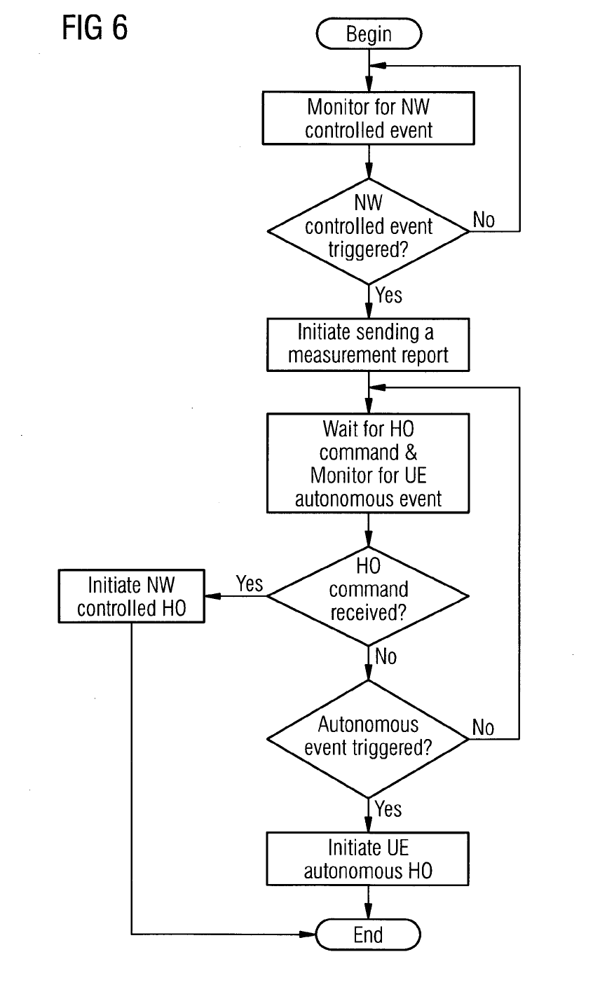

FIG. 6 shows a flow chart that illustrates a procedure such as that of FIG. 5 according to one embodiment. In this embodiment, a UE monitors for a NW controlled event and, if it is triggered (e.g. if the trigger parameters are satisfied), initiates sending a measurement report to the network. The UE then waits for the HO command in response to the measurement report from the network while monitoring for the UE autonomous event.

If the HO command is received from the network, the UE initiates NW controlled HO.

If the HO command is not received and the UE autonomous event has been triggered, the UE initiates UE autonomous HO.

The second TTT does not expire if UE receives HO command before expiry of the second TTT. In that case the user device may stop the second TTT timer and initiate network controlled HO according to the contents of the HO command signalling (e.g. RRC connection reconfiguration including MobilityControlInfo information element)

When NW controlled HO or UE autonomous HO is initiated, the UE stops monitoring and receiving the source cell.

Although the UE is shown monitoring for the UE autonomous event after the measurement report has been sent in FIG. 6, the measurement report sending may fail or be delayed, so monitoring for UE autonomous event may start (and the event may trigger) before the measurement report is successfully transmitted. Alternatively, the first event and the second event may be the same or occur at the same time (i.e. the TTTs may be started at the same time).

The network controlled event parameters and the UE autonomous event parameters may be different. For example the second time period may be greater than the first time period, such that the event triggering for UE autonomous HO has a delay compared to the NW controlled event (e.g. the (second level) triggering for UE autonomous HO could have some additional delay compared to the NW controlled event). This may allow time for HO preparation signalling between source and target eNBs as well as for HO signalling between source eNB and UE—so that the UE doesn't initiate the autonomous procedure if the NW controlled procedure is still on-going (and has not failed).

The second event may have the triggering conditions as the first event but with additionally configured triggering delay—e.g. longer TTT, such that the second time period is longer than the first time period. This may provide time for network controlled HO to succeed before initiating the UE autonomous HO. In one example the first time period comprises the event trigger, TTT and the second time period comprises an additional TTT_auto. When, for example, TTT expires, a measurement is sent to network (if possible) and UE awaits potential HO command. TTT_auto is still running and if TTT_auto expires this will lead to UE to trigger autonomous handover. This may mean that UE may start 2 TTTs at the same time, where the shorter one is for network controlled HO and the longer one for the UE autonomous mobility.

If the two e.g. TTTs are started at the same time, then the second level TTT could be configured longer to make the autonomous event trigger only if there is delay in network controlled event (e.g. due to LBT/CCA blocking the access to the medium and thus delay the handover signalling). In another exemplary embodiment, the autonomous UE controlled HO TTT is started when the network controlled HO event TTT expires, and in this case it doesn't need to be longer (as it is additional triggering time on top of the network controlled HO event), that is the second time period may be less than or equal to the first time period.

In an alternative embodiment, the measurement event configuration may include both NW controlled and UE autonomous triggering conditions. These are configured such that the NW controlled event triggers first—for example the NW controlled event may have shorter TTT and/or lower offset. In this case the TTT_auto may start at the same time (if using same offset), but the autonomous event would trigger later than the measurement report (i.e. NW controlled event).

An example configuration could be:
Measurement report is triggered based on A3 event with 2 dB offset, 0 dB hysteresis and 160 ms ITT
UE autonomous HO is triggered based on A3 event with 2 dB offset, 0 dB hysteresis and 160 ms+100 ms TTT.

The method may comprise providing the measurement report to the network and determining whether the measurement report was successfully provided to the network. That is the method may comprise a UE transmitting the measurement report and determining whether the network has acknowledged the transmission.

Different UE autonomous event triggering parameters (e.g. shorter TTT) may be used depending on whether a UE has successfully been able to send a measurement report for the associated NW controlled event. The UE may be configured with two second time periods, e.g. two TTTs for the autonomous event. If the measurement report is transmitted successfully the user device may determine to use the shorter of the two time periods and the longer of the two time periods otherwise. If the measurement report has been successfully provided, it may be assumed that the target eNB has been prepared with the UE context, i.e. that that the autonomous HO (e.g. using similar procedure to re-establishment) will succeed or at least doesn't suffer delay from fetching the context from the source eNB.

Additionally or alternatively, the UE autonomous event triggering parameters may be different (e.g. shorter TTT or lower threshold) depending on whether the target cell has been successfully reported to the network. That is, the UE may determine to use the shorter of the two second time periods if the target cell has been successfully reported to the network. In this case the network has been able to prepare the target cell with UE context. In some cases the autonomous event may apply to cells that have been reported to the network e.g. as a result of the associated NW controlled event triggering. This may be accomplished for example by starting the autonomous event monitoring only after measurement report triggered by the associated NW controlled event is successfully transmitted.

A method as described with reference to FIGS. 5 and 6 allows NW controlled mobility, which may desirable since the target cell will then be always prepared and better control is maintained in the network. However, in the cases (e.g. fast moving UEs or high load) where the NW controlled mobility may not perform as well, the UE may be configured also with an associated autonomous event that allows faster but still more controlled HO than RLF based mobility.

It should be understood that each block of the flowcharts of the Figures and any combination thereof may be implemented by various means or their combinations, such as hardware, software, firmware, one or more processors and/or circuitry.

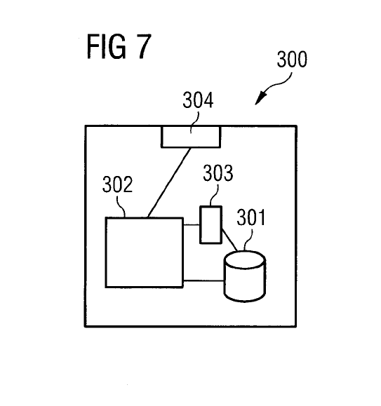

The method may be implemented on a mobile device as described with respect to FIG. 2. The method may be implanted in a single processor 201 or across more than one processor. FIG. 7 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions. Control functions may comprise determining, at a user device, the occurrence of a first event, the first event being an indication to, after a first time period, provide a measurement report to a serving access point of a network, determining, at the user device, whether a second event has occurred, the second event being an indication to, after a second time period, initiate user device controlled handover from the serving access point of the network, determining whether a handover command has been received from the network in response to the measurement report and prior to expiry of the second time period and, if not, determining to initiate user device controlled handover.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE networks, similar principles maybe applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
determining, at a user device, the occurrence of a first event, the first event being an indication to, after a first time period, provide a measurement report to a serving access point of a network;
determining, at the user device, whether a second event has occurred, the second event being an indication to, after a second time period, initiate user device controlled handover from the serving access point of the network;
determining whether a handover command has been received from the network in response to the measurement report and prior to expiry of the second time period; and, if not,
determining to initiate user device controlled handover.

2. A method according to claim 1, wherein the first time period is a time to trigger providing the measurement report from the first event and the second time period is a second time to trigger initiating user device controlled handover from the second event.

3. A method according to claim 1, wherein the second time period is greater than the first time period.

4. A method according to claim 1, comprising providing the measurement report to the network; and
determining whether the measurement report was successfully provided to the network.

5. A method according to claim 1, wherein the user device is configured with two second time periods, the two second time periods having different lengths, and comprising determining to use the shorter of the two second time periods if the measurement report has been successfully provided to the network and the longer of the two second time periods if the measurement report has not been successfully provided to the network.

6. A method according to claim 1, comprising providing the measurement report to the network prior to determining whether the second event has occurred.

7. A method according to claim 1, wherein the second time period is configured to begin on expiry of the first time period and the second time period is less than or equal to the first time period.

8. A method according to claim 1, wherein the first event comprises a neighbour access point having a first offset with respect to the serving access point.

9. A method according to claim 1, wherein the second event comprises a neighbour access point having a second offset with respect to the serving access point.

10. A method according to claim 8, wherein the first offset is less than or equal to the second offset.

11. A method according to claim 1, comprising performing a listen-before-talk procedure and determining to initiate user device controlled handover in dependence on whether the serving access point is available.

12. (canceled)

13. A computer program product for a computer comprising a non-transitory computer-readable storage medium bearing computer program code embodied therein for use with a computer, the computer program code comprising:
determining, at a user device, the occurrence of a first event, the first event being an indication to, after a first time period, provide a measurement report to a serving access point of a network;
determining, at the user device, whether a second event has occurred, the second event being an indication to, after a second time period, initiate user device controlled handover from the serving access point of the network;
determining whether a handover command has been received from the network in response to the measurement report and prior to expiry of the second time period; and, if not, determining to initiate user device controlled handover.

14. An apparatus comprising:
at least one processor and at least one memory including a computer program code, the at least one memory and the computer program code configured to, with the at least one processor, cause the apparatus at least to:
determine, at a user device, the occurrence of a first event, the first event being an indication to, after a first time period, provide a measurement report to a serving access point of a network;
determine, at the user device, whether a second event has occurred, the second event being an indication to, after a second time period, initiate user device controlled handover from the serving access point of the network;
determine whether a handover command has been received from the network in response to the measurement report and prior to expiry of the second time period; and, if not,
determine to initiate user device controlled handover.

15. An apparatus according to claim 14, wherein the first time period is a time to trigger providing the measurement report from the first event and the second time period is a second time to trigger initiating user device controlled handover from the second event.

16. An apparatus according to claim 14 wherein the second time period is greater than the first time period.

17. An apparatus according to claim 14, configured to provide the measurement report to the network; and
determine whether the measurement report was successfully provided to the network.

18. An apparatus according to claim 17, wherein the user device is configured with two second time periods, the two second time periods having different lengths, and configured to determine to use the shorter of the two second time periods if the measurement report has been successfully provided to the network and the longer of the two second time periods if the measurement report has not been successfully provided to the network.

19. An apparatus according to claim 14, configured to provide the measurement report to the network prior to determining whether the second event has occurred.

20. An apparatus according to claim 14, wherein the wherein the second time period is configured to begin on expiry of the first time period and the second time period is less than or equal to the first time period.
